(19) United States
(12) Patent Application Publication
(10) Pub. No.: US 2019/0219264 A1
(43) Pub. Date: Jul. 18, 2019

(54) EXHAUST DETECTING SAFETY SWITCH ASSEMBLY

(71) Applicant: William A. Guido, East Meadow, NY (US)

(72) Inventor: William A. Guido, East Meadow, NY (US)

(21) Appl. No.: 15/873,541

(22) Filed: Jan. 17, 2018

(51) Int. Cl. F23N 5/24; G01N 21/53

(52) U.S. Cl. CPC F23N 5/245; G01N 21/534; F23N 2039/06; F23N 2027/38; F23N 2029/00; F23N 2027/28

(57) ABSTRACT

An exhaust detecting safety switch assembly for turning off an oil burner when a disruptive quantity of exhaust is detected includes an oil burner. The oil burner ignites oil to define a flame when the oil burner is turned on. An ignition is positioned in and is in electrical communication with the oil burner. The ignition is actuated to ignite the oil. A shutoff is electrically coupled to the ignition and is actuated to turn the oil burner off when the shutoff no longer detects the flame. A safeguard unit is mounted on and is in fluid communication with the oil burner. The safeguard unit is electrically coupled to the ignition. The safeguard unit detects when the oil burner emits a disruptive quantity of opaque exhaust and when detected turns the oil burner off. The safeguard unit is positioned to inhibit access to the safeguard unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to safety switch devices and more particularly pertains to a new safety switch device for turning off an oil burner when a disruptive quantity of exhaust is detected.

### BRIEF SUMMARY OF THE INVENTION

An embodiment of the disclosure meets the needs presented above by generally comprising an oil burner that includes a chamber therein. The oil burner ignites oil in the chamber to define a flame when the oil burner is turned on to provide heat. An ignition is positioned in the oil burner and is in electrical communication with the chamber. The ignition is actuated to ignite the oil in the chamber. A main control switch is electrically coupled to the oil burner. The main control switch is actuated to turn on the oil burner. A shutoff is electrically coupled to the ignition. The shutoff is actuated to turn the oil burner off when the shutoff no longer detects the flame. A safeguard unit is mounted on and is in fluid communication with the oil burner. The safeguard unit is electrically coupled to the ignition and detects when the oil burner emits a disruptive quantity of opaque exhaust and turns the oil burner off when the disruptive quantity of opaque exhaust is detected. The safeguard unit is positioned to inhibit access to the safeguard unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front side view of an exhaust detecting safety switch assembly according to an embodiment of the disclosure.

FIG. 2 is a front view of an embodiment of the disclosure.

### DETAILED DESCRIPTION OF THE INVENTION

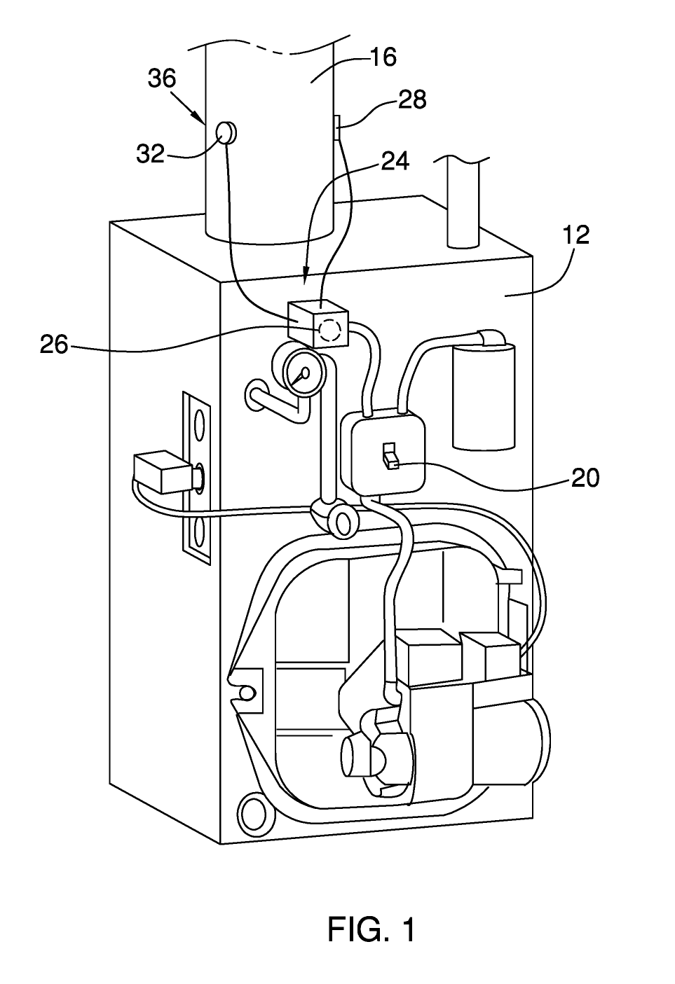

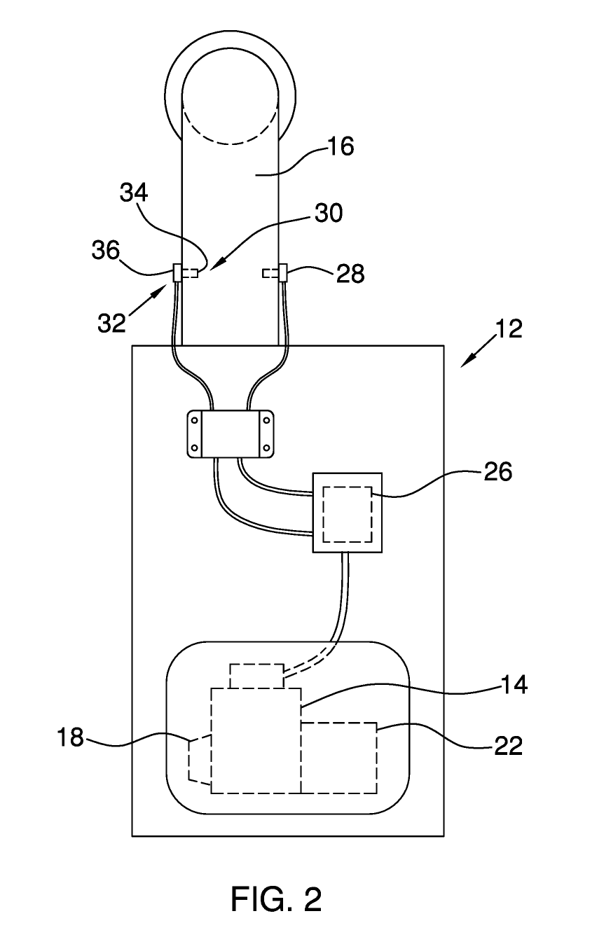

With reference now to the drawings, and in particular to FIGS. 1 through 2 thereof, a new safety switch device embodying the principles and concepts of an embodiment of the disclosure and generally designated by the reference numeral 10 will be described.

As best illustrated in FIGS. 1 through 2, the exhaust detecting safety switch assembly 10 generally comprises an oil burner 12 that includes a chamber 14 therein. The oil burner 12 ignites oil in the chamber to define a flame when the oil burner 12 is turned on to provide heat. A smoke pipe 16 is in fluid communication with the chamber 14.

An ignition 18 is positioned in the oil burner 12 and is in electrical communication with the chamber 14. The ignition 18 is actuated to ignite the oil in the chamber 14. A main control switch 20 is electrically coupled to the ignition 18 and is actuated to turn on the ignition 18. A shutoff 22 is electrically coupled to the ignition 18 and is actuated to turn the oil burner 12 off when the shutoff 22 no longer detects the flame.

A safeguard unit 24 is mounted on and is in fluid communication with the oil burner 12. The safeguard unit 24 is electrically coupled to the ignition 18. The safeguard unit 24 detects when the oil burner 12 emits a disruptive quantity of opaque exhaust and turns the oil burner 12 off when the disruptive quantity of opaque exhaust is detected. The safeguard unit 24 is positioned to inhibit access to the safeguard unit 24.

The safeguard unit 24 comprises a control circuit 26 that is mounted on the oil burner 12. The control circuit 26 is electrically coupled to the ignition 18. The control circuit 26 is sealed within the oil burner 12 to inhibit accessibility to the control circuit 26. A light emitter 28 is electrically coupled to the control circuit 26. The light emitter 28 is positioned on and is in fluid communication with the smoke pipe 16. The light emitter 28 emits a light into the smoke pipe 16 when turned on. The light emitter 28 is turned on after the oil burner 12 is actuated to an on position.

An electric eye 30 is electrically coupled to the control circuit 26. The electric eye 30 is positioned on and extends into the smoke pipe 16. The electric eye 30 is able to detect the light emitted by the light emitter 28. The control circuit 26 turns off the oil burner 12 when the disruptive quantity of opaque exhaust inhibits the electric eye 30 from detecting the light. The electric eye 30 comprises a photoresistor 32 that has an input end 34 and an output end 36. The input end 34 is positioned within the smoke pipe 16 and detects the light through the opaque exhaust emitted by the oil burner 12. The output end 36 is positioned outwardly of the smoke pipe 16 and is electrically coupled to the control circuit 26.

In one embodiment the photoresistor 32 comprises a cadmium sulfide cell. In this embodiment the input end 34 has a resistance between 300 to 1000 ohms when the visible light is detected. The resistance of the input end 34 increases as the opaque exhaust inhibits the electric eye 30 from detecting the light wherein the disruptive quantity of opaque exhaust is defined when the input end 34 has a resistance of at least 1600 ohms.

In use, the main control switch 20 is actuated to turn on the ignition 18 and ignite the oil within the chamber 14. The oil burner 12 then releases heat outwardly. The opaque exhaust produced by the flames flows outwardly through the smoke pipe 16. The electric eye 30 detects the light emitted by the light emitter 28 through the opaque exhaust. As the quantity of the opaque exhaust released increases the less light is detected by the electric eye 30 thereby increasing the resistance of the electric eye 30. The control circuit 26 detects the high resistance and shuts down the ignition 18 to turn off the oil burner 12. The control circuit 26 is sealed to inhibit access and require a user to seek out a certified technician to restart the oil burner 12 as well as check for issues that caused the release of the disruptive quantity of opaque exhaust

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An oil burner safety control system comprising:
an oil burner including a chamber therein, said oil burner igniting oil in said chamber to define a flame when said oil burner is turned on providing heat;
an ignition being positioned in said oil burner and being in electrical communication with said chamber, said ignition being actuated to ignite said oil in said chamber;
a main control switch being electrically coupled to said ignition, said main control switch being actuated to turn on said ignition;
a shutoff being electrically coupled to said ignition, said shutoff being actuated to turn said oil burner off when said shutoff no longer detects said flame; and
a safeguard unit being mounted on and being in fluid communication with said oil burner, said safeguard unit being electrically coupled to said ignition, said safeguard unit detecting when said oil burner emits a disruptive quantity of opaque exhaust and turning said oil burner off when said disruptive quantity of opaque exhaust is detected, said safeguard unit being positioned to inhibit access to said safeguard unit.

2. The oil burner safety control system according to claim 1, further including a smoke pipe being in fluid communication with said chamber.

3. The oil burner safety control system according to claim 2, wherein said safeguard unit comprises:
a control circuit being mounted on said oil burner, said control circuit being electrically coupled to said ignition;
a light emitter being electrically coupled to said control circuit, said light emitter being positioned on and being in fluid communication with said smoke pipe; and
an electric eye being electrically coupled to said control circuit, said electric eye being positioned on and extending into said smoke pipe.

4. The oil burner safety control system according to claim 3, wherein said control circuit is sealed within said oil burner to inhibit accessibility to said control circuit.

5. The oil burner safety control system according to claim 4, wherein said light emitter emits a light into said smoke pipe when turned on, said light emitter being turned on after said oil burner is actuated to an on position.

6. The oil burner safety control system according to claim 5, wherein said electric eye is able to detect said light emitted by said light emitter, said control circuit turning off said oil burner when said disruptive quantity of opaque exhaust inhibits said electric eye from detecting said light.

7. The oil burner safety control system according to claim 6, wherein said electric eye comprises a photoresistor having an input end and an output end.

8. The oil burner safety control system according to claim 7, wherein said input end is positioned within said smoke pipe and detects said light through said opaque exhaust emitted by said oil burner, said output end being positioned outwardly of said smoke pipe and being electrically coupled to said control circuit.

9. The oil burner safety control system according to claim 1, wherein said input end has a resistance between 300 to 1000 ohms when said visible light is detected, said resistance of said input end increasing as said opaque exhaust inhibits said electric eye from detecting said light wherein said disruptive quantity of opaque exhaust is defined when said input end has a resistance of at least 1600 ohms.

10. The oil burner safety control system according to claim 1, wherein said photoresistor comprises a cadmium sulfide cell.

11. An oil burner safety control system comprising:
an oil burner including a chamber therein, said oil burner igniting oil in said chamber to define a flame when said oil burner is turned on to provide heat, a smoke pipe being in fluid communication with said chamber;
an ignition being positioned in said oil burner and being in electrical communication with said chamber, said ignition being actuated to ignite said oil in said chamber;
a main control switch being electrically coupled to said ignition, said main control switch being actuated to turn on said ignition;
a shutoff being electrically coupled to said ignition, said shutoff being actuated to turn said oil burner off when said shutoff no longer detects said flame;
a safeguard unit being mounted on and being in fluid communication with said oil burner, said safeguard unit being electrically coupled to said ignition, said safeguard unit detecting when said oil burner emits a disruptive quantity of opaque exhaust and turning said oil burner off when said disruptive quantity of opaque exhaust is detected, said safeguard unit being positioned to inhibit access to said safeguard unit, said safeguard unit comprising:
a control circuit being mounted on said oil burner, said control circuit being electrically coupled to said ignition, said control circuit being sealed within said oil burner to inhibit accessibility to said control circuit;
a light emitter being electrically coupled to said control circuit, said light emitter being positioned on and being in fluid communication with said smoke pipe, said light emitter emitting a light into said smoke pipe when turned on, said light emitter being turned on after said oil burner is actuated to an on position; and
an electric eye being electrically coupled to said control circuit, said electric eye being positioned on and extending into said smoke pipe, said electric eye being able to detect said light emitted by said light emitter, said control circuit turning off said oil burner when said disruptive quantity of opaque exhaust inhibits said electric eye from detecting said light, said electric eye comprising a photoresistor having an input end and an output end, said input end being positioned within said smoke pipe and detecting said light through said opaque exhaust emitted by said oil burner, said output end being positioned outwardly of said smoke pipe and being electrically coupled to said control circuit, said input end having a resistance between 300 to 1000 ohms when said light is detected, said resistance of said input end increasing as said opaque exhaust inhibits said electric eye from detecting said light wherein said disruptive quantity of opaque exhaust is defined when said input end has a resistance of at least 1600 ohms, said photoresistor comprising a cadmium sulfide cell.
